(19) United States
(12) Patent Application Publication
(10) Pub. No.: US 2007/0122572 A1
(43) Pub. Date: May 31, 2007

(54) SINGLE-SEALED MULTILAYER TRANSPARENT UNIT

(75) Inventors: Takashi Shibuya, Chiyoda-ku (JP); Seigo Kotera, Chiyoda-ku (JP); Yoshitaka Matsuyama, Chiyoda-ku (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: ASAHI GLASS CO., LTD., Tokyo (JP)

(21) Appl. No.: 11/557,340

(22) Filed: Nov. 7, 2006

Related U.S. Application Data
(63) Continuation of application No. PCT/JP05/08237, filed on Apr. 28, 2005.

(30) Foreign Application Priority Data
May 7, 2004 (JP) 2004-138271

(51) Int. Cl. E06B 3/00

(52) U.S. Cl. 428/34

(57) ABSTRACT

To provide a single-sealed multi-layer transparent unit, particularly a double-glazing unit, excellent in shape retention and water vapor permeation resistance. In a single-sealed multi-layer transparent unit, particularly a double-glazing unit, wherein only an elastomer spacer is used, said elastomer spacer contains, as the matrix component, at least one butyl elastomer component selected from the group consisting of polyisobutylene, butyl rubber and modified butyl rubber; Molecular Weight Index (MWI) of the butyl elastomer component represented by the following formula (1) is at least 400,000: MWI=Σ(Mw(i)×(mass % of the i-th butyl elastomer component based on the total amount of all butyl elastomer components/100)) (1) (wherein i is an integer of at least 1 representing the number of types of butyl elastomer components contained as the matrix component in the elastomer spacer, and Mw(i) represents the viscosity-averaged molecular weight of the i-th butyl elastomer component); and the elastomer spacer contains no crystalline polyolefin or less than 2 mass % of crystalline polyolefin.

### TECHNICAL FIELD

The present invention relates to a single-sealed multilayer transparent unit, particularly a single-sealed double-glazing glass, wherein as a spacer, only an elastomer spacer is used which contains, as the matrix component, at least one butyl elastomer component selected from the group consisting of polyisobutylene, butyl rubber and modified butyl rubber, and a process for its production.

### BACKGROUND ART

Heretofore, a so-called double-glazing unit has been known which is usually composed of two sheets of flat glass with a spacer interposed. Such a double-glazing unit is used mainly for buildings or vehicles, and as shown in FIG. 4, it is usually of a type wherein a metal spacer 5 made of e.g. aluminum and butyl rubber 6 are disposed at a peripheral portion between two sheets of flat glass 1 and 2, and a secondary seal 7 is further disposed outside the metal spacer or the like. A double-glazing unit of such a construction is rather complex in the construction, and for the mass production at a low cost, it is required to introduce a relatively expensive installation for the production. Further, the metal spacer has a high thermal conductivity, and the metal spacer is likely to conduct heat from one side of the double-glazing unit to the other side. Accordingly, there has been a drawback that when such a unit is used for a window, the heat-insulating properties are insufficient.

It is considered possible that the heat insulating properties of a double-glazing unit can be improved by constituting the spacer and therearound of the double-glazing unit, i.e. the seal portion of the double-glazing unit, by a material having a low thermal conductivity. However, in the prior art, there have been many cases where the heat insulating properties and/or durability is not fully satisfactory. For example, a double-glazing unit employing a resin spacer has been known (see e.g. Patent Document 1). However, in this case, the resin spacer itself does not have an adequate water vapor barrier performance against water vapor which tends to penetrate into an air space of the double-glazing unit from exterior, whereby dew condensation is likely to take place in the air space of the double-glazing unit in a relatively short time after the initiation of its use. Thus, there has been a problem from the viewpoint of the durability.

Also known is one wherein the seal portion of a double-glazing unit is made of a primary seal layer of butyl material and an exterior secondary seal layer (see e.g. Patent Document 2). In such a case, the primary seal itself has a relatively low water vapor permeability, but with such a primary seal alone, it is difficult to maintain the shape as a double-glazing unit for a long period of time, and it has been required to dispose a so-called curable sealant as a secondary seal outside the primary seal portion. Further, use of such a curable sealant has had problems such that (i) the production cost increases, (ii) due to a restriction in the embedding depth of the double-glazing unit at the time of mounting the unit on a window, the thickness of the primary seal is obliged to be made thin for a thickness corresponding to the added secondary seal, whereby it tends to be difficult to secure the durability, and (3) even if a curable sealant is used as a secondary seal, it is required to maintain the shape of the entire double-glazing unit solely by the primary seal until the curable sealant will be cured, whereby heretofore, it has been difficult to completely prevent a deformation of the shape of the double-glazing unit by the weight of the unit itself.

A method for solving the above problems has been proposed by embedding a metal spacer in the butyl material (see e.g. Patent Document 3). However, even in a case where such a method is employed, the heat conducted via the metal spacer is not negligible, and the thermal conductivity of the seal portion tends to be larger than a case where only an organic material is used, and it has been desired to further reduce the thermal conductivity. Further, by the insertion of the metal spacer, it may be possible to prevent compression of the seal portion to avoid crushing of the air space in the double-glazing unit, but for example, it is not possible to sufficiently prevent the pair of flat glass from displacing in the shearing direction (substantially in the horizontal direction with the plane of the flat glass), and even in the case of a window glass to be practically used for buildings, in order to obtain practical durability, it has been required to form a secondary seal along the periphery of the glass in a case where the size is large (see e.g. Patent Document 2).

As a sealing material for a double-glazing unit, various compositions are known (see e.g. Patent Documents 4 to 7) for butyl elastomer material as a material for sealing a double-glazing unit employing polyisobutylene or butyl rubber as the matrix. However, any one of such materials can not maintain the shape of the double-glazing unit when it is used alone as the spacer for the double-glazing unit.

Further, a spacer material for a double-glazing unit has been proposed whereby the heat-insulating property, durability and shape retention of a double-glazing unit have been substantially improved by incorporating a predetermined amount of crystalline polyolefin into a conventional butyl elastomer to improve the mechanical properties of the butyl elastomer, particularly to reduce the creep compliance (see e.g. Patent Document 8).

It is considered that in the present invention, the material constituting the spacer is required to have a proper creeping property. As an index to show the creeping property, an elastic modulus with consideration of timer-scale dependence of deformation taken into account, or a creep compliance as an inverse thereof, may, for example, be mentioned. It is known that the two can be obtained from amount of the strain change when a so-called constant load is exerted. Eventually, the proper creeping property is nothing other than that amount of the strain change under exertion of a load is within a proper range.

On the other hand, in the present invention, the creeping property being good, the creeping property being small or the creeping property being low, means that the above-mentioned amount of the strain change is small, and this means that the above-mentioned elastic modulus is high, or the creep compliance is small. Inversely, the creeping property being poor, the creeping property being large or the creeping property being high, means that the above-mentioned amount of the strain change is large, and this means that the above-mentioned elastic modulus is low, or the creep compliance is high.

Accordingly, the creep compliance of a material becoming small means that the elastic modulus becomes high. However, there has been a case where the material to be used for a spacer for a double-glazing unit is required to be sufficiently bonded to glass and required to have flexibility to some extent, whereby it is undesirable that the elastic modulus is too high. Further, when the above butyl elastomer is employed as a spacer for a double-glazing unit, it is preferred that the butyl elastomer is bonded to the glass, but there has been a case where the bonding property of the spacer material to the glass tends to be low by the above-mentioned addition of a crystalline polyolefin.

Patent Document 1: EP0613990

Patent Document 2: JP-B-61-20501

Patent Document 3: U.S. Pat. No. 5,270,091

Patent Document 4: U.S. Pat. No. 4,198,254

Patent Document 5: U.S. Pat. No. 4,205,104

Patent Document 6: U.S. Pat. No. 4,226,063

Patent Document 7: U.S. Pat. No. 3,832,254

Patent Document 8: WO97/23561

### DISCLOSURE OF THE INVENTION

### Objects to be Accomplished by the Invention

Therefore, the present invention is to provide an elastomer spacer to be used as a spacer for a double-glazing unit, which is excellent in mechanical strength and thus provides a good shape retention for the double-glazing unit even without using a metal spacer and which has a low water vapor permeability and is excellent in adhesion, a single-sealed double-glazing unit employing such a spacer, and a process for its production. Further, the present invention is to provide a multilayer transparent unit employing plate-like transparent material, not limited to such a double-glazing unit, and a process for its production.

### MEANS TO ACCOMPLISH THE OBJECTS

A first embodiment of the single-sealed multilayer transparent unit of the present invention is a single-sealed multi-layer transparent unit, wherein as a spacer, is only an elastomer spacer is used, and said spacer is disposed at a peripheral portion between at least two sheets of plate-like transparent material facing one another, and wherein said elastomer spacer contains, as the matrix component, at least one butyl elastomer component selected from the group consisting of polyisobutylene, butyl rubber and modified butyl rubber; Molecular Weight Index (MWI) of the butyl elastomer component represented by the following formula (1) is at least 400,000:

$$MWI = {\sum }_{i} ( Mw ( i ) \times ( mass \% of the i \text{-} th butyl elastomer component based on the total amout of all butyl elastomer components / 100 ) )$$

(wherein i is an integer of at least 1 representing the number of types of butyl elastomer components contained as the matrix component in the elastomer spacer, and Mw(i) represents the viscosity-averaged molecular weight of the i-th butyl elastomer component); and the elastomer spacer contains no crystalline polyolefin.

Further, a second embodiment of the single-sealed multilayer transparent unit of the present invention is one wherein the above elastomer spacer contains less than 2 mass % of crystalline polyolefin.

Further, in each of the above single-sealed multilayer transparent units, it is preferred that the elastomer spacer contains, as filler components, a drying agent and at least one member selected from the group consisting of carbon black, coloring pigment and inorganic filler, and such filler components are contained in a total amount of from 40 to 75 mass % in the elastomer spacer.

Further, in each of the above single-sealed multilayer transparent units, it is preferred that the melt volume rate (MVR) of the material for the elastomer spacer is at most 0.1 cm³/sec, as measured in accordance with JIS K7210 (1999) by means of a Koka-type flow tester at 150° C. under a load of 55 kgf (539N) under a condition of die length (L)/die diameter (D)=5 mm/1 mm.

Further, in each of the above single-sealed multilayer transparent units of the present invention, it is particularly preferred that the plate-like transparent material is flat glass, and the single-sealed multi-layer transparent unit is a single-sealed double-glazing unit.

The process for producing a single-sealed multilayer transparent unit of the present invention comprises producing a string-like elastomer spacer having prescribed size and shape as said elastomer spacer, by extrusion, then disposing the string-like elastomer spacer all around inside the periphery of the plate-like transparent material, and overlaying another plate-like transparent material to face said plate-like transparent material with the string-like elastomer spacer interposed.

### EFFECTS OF THE INVENTION

According to the present invention, by adopting the above construction, it is possible to lower the creeping property of the spacer material and to obtain a single-sealed multilayer transparent unit excellent in the shape retention ability. Further, it is possible to obtain a multilayer transparent unit excellent in durability, wherein the bonding state between the plate-like transparent material and the spacer is good, and the water vapor permeability of the spacer material is low.

### BRIEF DESCRIPTION OF DRAWINGS

FIG. 1 is a schematic view of a single-sealed double-glazing unit of the present invention as viewed from the front.

FIG. 2 is a schematic view of a portion at the A-A′ cross section (FIG. 1) of the single-sealed double-glazing unit employing no adhesive.

FIG. 3 is a schematic view of a portion at the A-A′ cross section (FIG. 1) of the single-sealed double-glazing unit employing an adhesive.

FIG. 4 is a schematic view of a portion of a cross section of a conventional double-glazing unit.

### MEANINGS OF SYMBOLS

1: flat glass, 2: flat glass, 3: elastomer spacer, 4: adhesive, 5: aluminum spacer, 6: butyl rubber, and 7: secondary seal

### BEST MODE FOR CARRYING OUT THE INVENTION

The present inventors have conducted a study with an aim to improve the mechanical properties of an elastomer material, particularly to lower the creeping property, so that the elastomer material can be used alone as a spacer for a single-sealed multilayer transparent unit, particularly for a single-sealed double-glazing unit (hereinafter also referred to simply as a double-glazing unit). As a result, it has been found possible to obtain a multilayer transparent unit, particularly a double-glazing unit, which is excellent in shape retention and has little water vapor permeability and which is excellent in the thermal insulating property, by using, as the above-mentioned spacer, a single-layer elastomer spacer substantially alone, wherein the elastomer spacer contains, as the matrix component, at least one butyl elastomer component selected from the group consisting of polyisobutylene, butyl rubber and modified butyl rubber, and as such a butyl elastomer component, a material having Molecular Weight Index (MWI) of at least 400,000 is used.

Further, it has been found possible to lower the creeping property of the spacer material by incorporating fillers to the elastomer material constituting the spacer in a larger amount than in conventional cases, i.e. by incorporating a drying agent and at least one component selected from the group consisting of carbon black, coloring pigment and inorganic filler in a total amount of from 40 to 75 mass % in the elastomer spacer. Further, it has been found possible to obtain a multilayer transparent unit, particularly a double-glazing unit, having particularly excellent shape retention, when the melt volume rate (MVR) of the material for the elastomer spacer is at most 0.1 cm³/sec, as measured in accordance with JIS K7210 (1999) by means of a Koka-type flow tester at 150° C. under a load of 55 kgf (539N) under a condition of die length (L)/die diameter (D)=5 mm/1 mm.

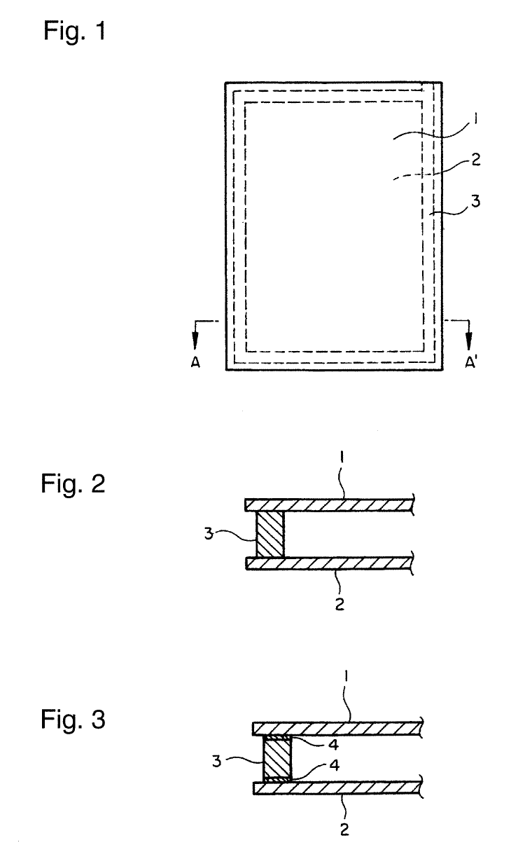

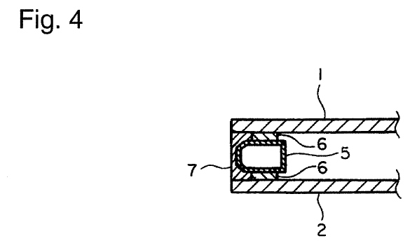

Now, the multilayer transparent unit of the present invention will be described in detail. A typical one is a double-glazing unit, and therefore, the construction of the present invention will be described with reference to the double-glazing unit, but it should be understood that the present invention is not limited to the double-glazing unit. The double-glazing unit of the present invention is a double-glazing unit wherein the seal portion is constituted by an elastomer spacer, and is a double-glazing unit of a so-called single-sealed construction, which has no other seal outside (on the outer peripheral side) of the seal portion. One embodiment of the double-glazing unit of the present invention is schematically shown in FIGS. 1 to 3. FIG. 1 is a schematic view showing the double-glazing unit as viewed from the front, and FIGS. 2 and 3 are schematic views showing cross sections of the double-glazing unit as observed from its side. In this case, two sheets of flat glass 1 and 2 are disposed to face each other, and as shown in FIG. 1, an elastomer spacer 3 (hereinafter sometimes referred to simply as a spacer 3) is disposed in the vicinity of the periphery i.e. at the peripheral portion between the flat glass and the flat glass to constitute a single-sealed double-glazing unit.

Between the spacer 3 and the flat glass 1, and between the spacer 3 and the flat glass 2, an adhesive 4 may or may not be used depending upon the composition of the material for the spacer to be used. FIGS. 2 and 3 respectively show cross-sectional views of the seal portions of single-sealed double-glazing units wherein no adhesive is used and an adhesive is used between each flat glass and the spacer. Here, FIGS. 1 to 3 show a case of a double-glazing unit constituted by two sheets of glass disposed to face each other, but three or more sheets of glass may be employed to constitute a multilayer unit having a spacer disposed between the respective glass sheets.

Flat glass is most common as the plate-like transparent material constituting the multilayer transparent unit of the present invention. However, the present invention is not limited to such flat glass, and in some cases, glass having a curved surface may, for example, be used. As flat glass to be used for the double-glazing unit of the present invention, flat glass, tempered glass, laminated glass, wired glass, heat-absorbing glass, etc. which are commonly widely used for windows and doors for buildings, vehicles, etc. as well as flat glass having a thin metal or other inorganic substance coated on its surface, such as heat reflective glass or low reflective glass, may be mentioned. Further, in the multilayer transparent unit of the present invention, as the plate-like transparent material, a plate-like transparent resin material so-called organic glass, that consists of an acrylic resin or polycarbonate resin. Further, such a transparent plate-like resin material and flat glass may be used in combination to constitute the multilayer transparent unit of the present invention.

In the present invention, as the spacer for the double-glazing unit, only an elastomer spacer is used, and it is not necessary to use any other spacer such as a metal spacer. The elastomer spacer of the present invention is made of a material which contains, as the matrix component, at least one butyl elastomer selected from the group consisting of polyisobutylene, butyl rubber and modified butyl rubber (hereinafter generally referred to as butyl elastomers).

Here, the polyisobutylene is meant for a homopolymer of isobutylene, and the butyl rubber is meant for a copolymer obtainable by copolymerizing isobutylene with a relatively small amount of isoprene. The above modified butyl rubber may, for example, be halogenated butyl rubber, or partially crosslinked butyl rubber. Among butyl elastomers to be used in the present invention, particularly preferred is a copolymer of isobutylene with isoprene, which is usually called butyl rubber, or partially crosslinked butyl rubber.

The butyl elastomer component contained in the matrix component of the elastomer spacer of the present invention is characterized in that Molecular Weight Index (MWI) of the butyl elastomer component represented by the following formula (1) is at least 400,000:

$$MWI = {\sum }_{i} ( Mw ( i ) \times ( mass \% of the i \text{-} th butyl elastomer component based on the total amount of all butyl elastomer components / 100 ) ) \qquad ( 1 )$$

In the above formula (1), i is an integer of at least 1 representing the number of types of butyl elastomer components contained as the matrix component in the elastomer spacer, and Mw(i) represents the viscosity-averaged molecular weight of the i-th butyl elastomer component. Here, the types of the butyl elastomer components mean that elastomer components different in the chemical composition are taken as different types, and butyl elastomers separately produced and having different viscosity-averaged molecular weights are taken as different types even if they have substantially the same chemical composition.

The above formula (1) means that in a case where the butyl elastomer component contains i-types of components, the MWI is a value obtained by totaling the products of the proportions of the respective butyl elastomer components occupying in the total amount of all butyl elastomer components, and the viscosity-averaged molecular weights of the respective components, with respect to all of i-types of components.

In the present invention, butyl elastomer components to be used are suitably selected so that the above MWI would be at least 400,000. Further, the above MWI is preferably from 400,000 to 3,000,000, particularly preferably from 400,000 to 1,000,000. By adjusting the above MWI to be at least 400,000, it is possible to obtain a double-glazing unit capable of maintaining the shape even under various situations in the practical application environment.

Further, in the present invention, a hydrophobic elastomer component other than the butyl elastomer may be incorporated to the spacer material in place of a part of the butyl elastomer. As such a hydrophobic elastomer, an ethylene/propylene copolymer rubber, various olefin elastomers or fluoro-rubber may, for example, be mentioned. In the present invention, the above butyl elastomer component with MWI being at least 400,000 is preferably contained at least 50 mass %, particularly preferably at least 75 mass %, in the entire components constituting the matrix contained in the spacer material.

The elastomer spacer of the present invention is preferably prepared from a material which comprises the above butyl elastomer as the matrix component, and filler components. The filler components to be incorporated to the butyl elastomer may be classified into a so-called drying agent having an ability to absorb and/or adsorb water vapor and one being not a drying agent. As the drying agent, silica gel or zeolite may, for example, be mentioned, and zeolite is particularly preferred. The latter may, for example, be carbon black, a coloring pigment, calcium carbonate, talc, mica, wollastonite, granular silica, water-containing silica, fumed silica, glass fiber or resin fiber. However, the filler components to be used in the present invention are not limited thereto, and all kinds of fillers which can be commonly used in resins or rubbers, may be used, and in the present invention, such fillers may be used alone or in combination as a mixture of two or more of them.

Particularly preferred as the material for the elastomer spacer to be used in the present invention is, for example, a material which comprises the above butyl elastomer as the matrix component and, as fillers, a drying agent and at least one member selected from the group consisting of carbon black, coloring pigment and inorganic filler. By incorporating the drying agent in the spacer, the water vapor-adsorbing ability can be imparted to the spacer material itself, whereby penetration of water vapor into the interior of the air space of the double-glazing unit can be prevented. Further, by using at least one member selected from the group consisting of carbon black, coloring pigment and inorganic filler as a filler for the spacer material, it is possible to prevent deterioration of the product quality due to coloration or color change of the spacer itself or to improve the mechanical properties. Further, the filler components are contained preferably in a total amount of from 40 to 75 mass %, more preferably from 45 to 60 mass %, particularly preferably from 50 to 60 mass %, in the elastomer spacer. It is preferred to increase the filler content to some extent in this manner, whereby the creeping property of the spacer material can be made low, and the shape retention ability can be increased.

The elastomer spacer to be used in the present invention is characterized by having the shape retention ability of the double-glazing unit solely by this spacer. In such a case, the melt volume rate (MVR) of the elastomer spacer material constituting the spacer is preferably at most 0.1 cm³/sec. The MVR is a value as measured in accordance with JIS K7210 (1999) by means of a Koka-type flow tester at 150° C. under a load of 55 kgf (539N) under a condition of die length (L)/die diameter (D)=5 mm/1 mm. By adjusting MVR to such a value, it is possible to obtain a double-glazing unit excellent in the shape retention ability. By suitably adjusting the value of Molecular Weight Index (MWI) of the butyl elastomer to be used as a spacer material, and the types and amounts of the fillers to be added to this elastomer, it is possible to bring MVR of the material constituting the spacer to a level of at most 0.1 cm³/sec. However, particularly preferred is one which, as mentioned above, contains a prescribed butyl elastomer component as the matrix component; has MWI of at least 400,000, and contains a drying agent and at least one member selected from the group consisting of carbon black, coloring pigment and inorganic filler, as filler components, and wherein the such filler components are contained in a total amount of from 40 to 75 mass % in the elastomer spacer material, so that the above MVR is adjusted to be at most 0.1 cm³/sec. Usually, as the content of fillers in the material for the elastomer spacer is increased, MVR tends to be small, and as the MWI value of the butyl elastomer component is made large, MVR tends to be small.

Here, when the creeping phenomenon of the spacer material is considered, the creeping phenomenon can be understood as a flow behavior of the material over a long time. The flow behavior of a non-crystalline polymer material ascertained after expiration of a long time is considered to be equivalent to the flow behavior in a short time at a high temperature, and this is a principle generally applicable to a non-crystalline polymer material, as a time-temperature superposition principle in this technical field. According to this principle, the rheology behavior upon expiration of a long time of a non-crystalline polymer material at a certain temperature is equivalent to the rheology behavior in a short time at a temperature higher than such a temperature, and the relation (the conversion formula) between the temperature and the time may be summarized by a certain empirical formula (known as the WLF formula). Consequently, it may be said that a non-crystalline polymer material having a lower flowability in a short time at a high temperature, will also have a low flowability even for a long time at a low temperature, i.e. the creeping property is low. In the present invention, Melt Volume Rate (MVR) of the elastomer spacer material constituting the spacer is adjusted to be preferably at most 0.1 cm³/sec, whereby the shape retention ability can be made high while the creeping property of spacer material for a double-glazing unit around room temperature is made low.

In WO97/23561, it has been proposed to increase the shape retention ability of a spacer by lowering the creeping property of the spacer material by an addition of a crystalline polyolefin into the spacer material. However, with the elastomer spacer of the present invention, the shape retention ability of the spacer can be increased by adjusting MWI of the butyl elastomer to be used to have a large value at a level of at least 400,000, as mentioned above. Accordingly, even when a crystalline polyolefin is added to the spacer of the present invention in order to increase the shape retention ability of the spacer, its content is not required to be large, and if the content is made large, it may rather happen that the adhesion of the butyl elastomer to the plate-like transparent material tends to be low. Accordingly, to the elastomer spacer of the present invention, no crystalline polyolefin may be contained, or even if it is contained, it is preferably less than 2 mass %, based on the elastomer spacer.

Adhesive for the Spacer and Flat Glass

As mentioned above, in the double-glazing unit of the present invention, an adhesive may or may not be used, as the case requires, between the flat glass and the spacer, as shown in FIG. 2 or 3. However, the one using an adhesive in order to increase the bond strength at the interface between the glass and the spacer, as shown in FIG. 3, is preferred, since the adhesion between the spacer and the flat glass can be made high, and it is thereby possible to further increase the durability as the double-glazing unit.

The adhesive to be used in the present invention is any material so long as it is a material capable of bonding the spacer and the glass, particularly the butyl elastomer and the glass, and it may, for example, be a polyester adhesive, an urethane adhesive or a silane is coupling agent and is not particularly limited. However, as an adhesive particularly suitable for the present invention, an adhesive (a) containing a combination of a polyester polyol and a polyisocyanate or its reaction product, or an adhesive (b) containing, as an effective component, a polymer or prepolymer obtainable by reacting a terminal reactive oligomer having butylene groups as repeating units with a chain extender, may, for example, be mentioned.

As the above adhesive (a), an adhesive is preferred which is prepared by using at least one aliphatic dicarboxylic acid as a raw material, a high molecular weight polyester polyol having a polystyrene-converted average molecular weight of at least 10,000 as the base compound, and a polyisocyanate containing at least two isocyanate groups per molecule, as a curing agent. Here, the polystyrene-converted average molecular weight is an average molecular weight measured by gel permeation chromatography using tetrahydrofuran as an eluent and using a monodisperse polystyrene sample having a known molecular weight as the standard. The above polyisocyanate may, for example, be a polyisocyanate selected from 2,4-tolylene diisocyanate, 2,6-tolylene diisocyanate, phenylene diisocyanate, xylene diisocyanate, 4,4′-diphenylmethane diisocyanate, triphenylmethane triisocyanate and naphthylene-1,5-diisocyanate, and hydrogenated compounds thereof; ethylene diisocyanate, propylene diisocyanate, tetramethylene diisocyanate, hexamethylene diisocyanate, isophorone diisocyanate, 1-methyl-2,4-diisocyanatecyclohexane, 1-methyl-2,6-diisocyanatecyclohexane, and dicyclohexylmethane diisocyanate, an adduct of such a polyisocyanate with a polyol compound such as trimethylolpropane, and a burette or nurate compound of such a polyisocyanate.

In order to have the bond strength between the spacer and flat glass developed swiftly, it is preferred to employ an aromatic polyisocyanate as the adhesive component. Further, in order to increase the compatibility of the adhesive with the spacer material to be used in the present invention thereby to improve the bond strength, it is preferred to use an aliphatic polyisocyanate as the adhesive component. Such polyisocyanates may be used alone or in combination as a mixture of two or more of them. The amount of the polyisocyanate contained in the adhesive is not particularly limited, but it is preferred to prepare the adhesive composition in a blend ratio such that isocyanate groups are contained in an amount of from 1 to 10 times in equivalent to the hydroxyl groups of the polyester polyol, whereby the curability of the adhesive can be made excellent.

It is preferred to have a silane coupling agent further incorporated to the above adhesive (a), whereby the bond strength between the flat glass and spacer can be increased. The silane coupling agent to be used in such a case may, for example, be a hydrolysable silyl group-containing compound having at least one type of groups selected from an epoxy group, an amino group and a mercapto group in its molecule, which may, for example, be γ-glycidoxypropyl trimethoxysilane, di(γ-glycidoxypropyl)dimethoxysilane, β-(3,4-epoxycyclohexyl)ethyl trimethoxysilane, γ-aminopropyl triethoxysilane, N-β-aminoethyl-γ-aminopropyl dimethoxymethylsilane, γ-(N-phenylamino)propyltrimethoxysilane, mercaptopropyl trimethoxysilane or mercaptopropyl triethoxysilane.

The amount of such a silane coupling agent to be incorporated to the adhesive composition is not particularly limited, but usually, it is preferred to employ it in an amount of from 0.05 to 10 parts by mass per 100 parts by mass of the total amount of the polyester polyol and the polyisocyanate contained in the adhesive, from the viewpoint of e.g. the balance of the effect for improving the bond strength and the economical efficiency.

In the above adhesive (b), the terminal reactive oligomer having butylene groups as repeating units, is a compound having a main chain containing bivalent hydrocarbons with four carbon atoms as repeating units and having, at its terminals, reactive functional groups selected from hydroxyl groups, carboxyl groups, amino groups, mercapto groups, epoxy groups, isocyanate groups, etc. Such a terminal reactive oligomer is a compound which can be made to be a high molecular weight polymer functioning as an adhesive, by reacting it with a chain extender having functional groups capable of reacting with such terminal functional groups to elongate or crosslink the oligomer molecular chains.

The butylene groups as the above-mentioned repeating units, may, for example, be an ethylethylene group (—CH₂CH(CH₂CH₃)—), a 1,2-dimethylethylene group (—CH(CH₃)—CH(CH₃)—), a 1,1-dimethylethylene group (—C(CH₃)₂—CH₂—) and a tetramethylene group (—(CH₂)₄—). As the above terminal reactive oligomer to be used in the present invention, a reactive oligomer having ethylethylene groups as repeating units and hydroxyl groups at the molecular terminals and having a polystyrene-converted molecular weight of at most 10,000, is particularly preferred, since the molecular main chain is flexible.

Further, the chain extender to be reacted with the above terminal reactive oligomer may, for example, be at least one polyisocyanate having trifunctional or higher functional isocyanate groups, at least one silane coupling agent having trifunctional or higher functional hydrolysable alkoxysilyl groups, a compound having trifunctional or higher functional double bonds, or a radical initiator for reacting them. Such a chain extender may be used also as a blend containing other additives such as a diluent, etc.

Among them, it is preferred to employ the above-mentioned polyisocyanate as the chain extender, whereby the storage stability such as pot life will be good.

To the above adhesive (a) or (b), additives selected from a solvent, a catalyst, a pigment, a filler, an antioxidant, a thermal stabilizer and an aging-preventive agent may suitably be added as the case requires. The amounts of the above chain extender and the above additives may suitably be determined as the case requires.

Process for Producing Double-Glazing Unit

A preferred process for producing the double-glazing unit of the present invention is as follows. Namely, the elastomer material for a spacer having a prescribed composition as described above is preliminarily formed into a string having prescribed size and shape by extrusion. In such a case, the size and shape, particularly the shape in cross section of the string can suitably be set and can be determined depending upon the designed values such as the size of the double-glazing unit to be produced and the thickness, etc. of the air space between glass sheets.

Then, this string-like elastomer spacer is disposed all around inside the periphery of the flat glass. At that time, as shown in FIG. 1, it is preferred to let one end of the string-like elastomer spacer abut against the spacer itself to increase the adhesion at the joint portion of the spacer in order to make closed air spaces among glasses or transparent plates. At the abutting joint portion, the joint state may be formed at the interface simply by bringing the material in contact with each other, but in order to further strengthen the adhesion at the joint portion, the two portions of the material to be joined may be heated and then contacted, or the two portions may be press-bonded under a pressure at a level not to substantially deform the shape of the spacer, or both of such operations may be carried out. Then, another flat glass is overlaid on the above flat glass to face therewith, with such a string-like elastomer spacer interposed, and after heating as the case requires, they are press-bonded. At that time, the above-mentioned adhesive may be applied between the flat glass and the elastomer spacer, as the case requires. Further, in the present invention, instead of the flat glass, other transparent materials such as plate-like transparent resins may also be used, or the flat glass may be used in combination with another transparent material such as a plate-like transparent resin.

### EXAMPLES

Now, the present invention will be described in further detail with reference to Examples and Comparative Examples, but the present invention is by no means restricted by such Examples.

Preparation of Single-Sealed Multilayer Transparent Unit (Double-Glazing Unit)

Now, Examples for producing the double-glazing unit of the present invention will be described. However, in the actual production of double-glazing units, the respective test specimens were produced by using flat glass having prescribed size and thickness required for the respective evaluation tests which will be described hereinafter.

### Example 1

Materials selected from three types of polyisobutylene (Oppanol B12, Oppanol B100 and Oppanol B150, tradenames) manufactured by BASF as polyisobutylene, crystalline polyolefin (tradename: High Density Polyethylene KM870A) manufactured by Nippon Polyolefin, a tackifier (Escorez 228F, tradename, manufactured by Tonex Company Limited), LMS-300 (tradename), manufactured by Fuji Talc Industrial Co., Ltd. as inorganic filler, carbon black, SEAST 3 (tradename) manufactured by Tokai Carbon Co., Ltd. as coloring pigment, and Zeolite 4A powder manufactured by Asahi Glass Company Limited as a drying agent, were put into a 150 L pressure kneader in the proportions by mass % as indicated in Table 1 and in a total amount of 160 kg, followed by kneading for 30 minutes. The obtained composition was extruded by means of a rubber extruder manufactured by Toshin Co, Ltd. at an extruder barrel temperature of 90° C. at a die temperature of 120° C. to obtain an elastomer spacer containing a butyl elastomer component and having a rectangular cross section of 7.5 mm×12.5 mm. On flat glass having a polyurethane adhesive coated all around inside the periphery, the above spacer was disposed so that the side of 7.5 mm of the spacer was in contact, and another sheet of flat glass also having a polyurethane adhesive coated all around inside the periphery was overlaid on the spacer so that the polyurethane adhesive was in contact with the spacer and so that such two sheets of flat glass faced each other. Then, such an entire assembly was heated and press-bonded by a heat roller pressing machine until an air space became 12 mm, to obtain a test specimen 1.

Here, the polyurethane adhesive employed as described above, was prepared as follows. Firstly, 50 g of a hydrogenated product of 1,2-polybutadiene (terminal hydroxyl groups, hydroxyl value: 50.8 mgKOH/g) and 478 g of isophorone diisocyanate were mixed, heated and stirred at 80° C. for 2 hours and then further heated and stirred at 12° C. for 20 hours. The obtained reaction mixture was cooled, and 200 g of a solvent obtained by mixing equal amounts of toluene and methyl ethyl ketone, was added to dissolve the mixture to obtain a solution A having a solid content of about 20 mass %. On the other hand, 28.9 g of an ethyl acetate solution containing 75 mass % of trimethylolpropane-modified isophorone diisocyanate was heated to 80° C., and 50 g of a methyl ethyl ketone solution containing 40 mass % of the hydroxyl group-terminated 1,2-polybutadiene hydrogenated product (the same one as above) was dropwise added thereto. The mixture was heated to 120° C. with stirring in a nitrogen atmosphere and then reacted for 2 hours. Then, the solvent was distilled, followed by cooling, and the mixture was diluted with a solvent having equal amounts of toluene and methyl ethyl ketone mixed to obtain a solution B having a solid content of about 20 mass %. Then, the solution A and the solution B were mixed, and γ-aminopropyl triethoxysilane was added in an amount of 5 parts by mass per 100 parts by mass of the solid content, to obtain the polyurethane adhesive.

### Examples 2 to 6 and Comparative Examples 1 to 3

Using the same method as the method in Example 1, test specimens of Examples 2 to 6 (hereinafter referred to as test specimens 2 to 6, respectively) and Comparative Examples 1 to 3 (hereinafter referred to as comparative test specimens 1 to 3, respectively) were prepared in accordance with the respective compositions shown in Table 1. Here, in Example 6, Vistanex MML (tradename) manufactured by Exxon was used as polyisobutylene. Further, Oppanol B50 used in Comparative Example 1 and Oppanol B80 used in Example 2, etc., are tradenames for polyisobutylene manufactured by BASF, respectively. Here, in Comparative Example 2, the prescribed materials shown in Table 1 were mixed and kneaded by a kneader 1 one hour, and even then, no continuous matrix of elastomer was formed, and no rubber-like composition was obtained, which could be used for the following tests.

Further, the values shown as viscosity-averaged molecular weights of polyisobutylenes in Table 1 are numerical values disclosed in the Oppanol products brochure of BASF and in the Vistanex product brochure of Exxon. Various methods are known as methods to define molecular weights of polymers. A molecular weight obtained from an experimental value of an intrinsic viscosity by using a relational formula (Mark-Houwink-Sakurada formula) between the viscosity of infinite dilution solution i.e. the intrinsic viscosity [η] and the molecular weight, is usually called a viscosity-averaged molecular weight. In the case of e.g. polyisobutylene or butyl rubber, a solution having a concentration of 0.01 g/cm³ is prepared by using isooctane as a solvent, and a Staudinger index J0 (cm³/g) is measured at 20° C. by means of an Ubbelohde viscometer. And, the viscosity-averaged molecular weight Jv can be calculated by means of the following relational formula:
J0=3.06×10⁻²Mv^{0.65}
Merchantability Tests of Double-Glazing Units

Using the above test specimens 1 to 6 and Comparative test specimens 1 and 3, evaluation of the performance of double-glazing units was carried out, the evaluation carried out was as follows. Here, the loading conditions, etc. in the tests were determined taking into consideration the sizes, types, loaded situations, etc. of the units to be actually used.

Opening and Closing Test

This test is a test for the purpose of evaluating the opening and closing impact durability under the practical operation conditions. Specifically, a double-glazing unit is prepared as described above by using two sheets of flat glass of 791 mm×1180 mm×3 mm in thickness, and the unit is mounted on a double sliding sash for window, and an operation of opening and closing once very 5 seconds was repeated 100,000 times in an environment of 25° C. Then, the double-glazing unit was taken out from the sash, and the change in thickness of the double-glazing unit as between before and after the test was measured at each corner and at a center point in each side. Further, in this test, the change in thickness is preferably small, and a case where the change was not more than 2 mm was regarded as “acceptable”. The obtained results are shown in Table 2 as “Opening and closing test”.

Sheet Displacement Test

The purpose of this test is to evaluate the sheet displacement resistance of a double-glazing unit in a cantilever state resulting at the time of transporting the double-glazing unit i.e. in the state of transporting in a state where only one flat glass of the double-glazing unit is supported. Specifically, a double-glazing unit employing two sheets of flat glass having a size of 350 mm×500 mm×3 mm in thickness, was prepared. It was held for 1 hour while one flat glass was secured, and to the other flat glass, a load of 13 kgf (127.5 N) was exerted in the displacement direction parallel to the plane of the unit by means of a suction disk. Upon expiration of 1 hour, the degree of displacement (displacement degree) in the load direction of the flat glass to which the load was exerted, was measured at each corner, based on the other flat glass, and its average value was obtained. Here, the smaller the displacement degree, the better, and a case where the displacement degree was not more than 2 mm, was regarded as “acceptable”. The obtained results are shown as “Sheet displacement test”.

Jis Durability Evaluation

The durability test evaluation (Class III) of double-glazing units stipulated in JIS R3209 (1998) was carried out. The test was carried out in accordance with JIS R3209 (1998). The obtained results are shown as “JIS R3209 (1998) Class III” in Table 2.

Glass Interface-Forming Test

The purpose of this test is to evaluate the adhesion of the spacer material to the flat glass. Specifically, a string-like spacer obtainable by extrusion of a spacer material having the composition shown in Table 1 into a string having a substantially rectangular cross section of 7 mm×12.5 mm, was disposed on the surface inside of the periphery of a flat glass of 350 mm×500 mm×3 mm in thickness placed substantially horizontally so that a surface of the spacer having a width of 7 mm was in contact therewith, and another flat glass having the same shape was placed thereon, and the assembly was passed through a heat roller press and press-bonded so that the thickness of the spacer became 12 mm. The bonded unit was left to stand still at room temperature for 24 hours, whereupon the interface where the flat glass and the spacer were in contact, was visually observed, and the state was evaluated by the following ◯ or X, and the obtained results are shown in Table 2.

◯: No air bubbles are observed at the bonded surface between the flat glass and the spacer, and the width of the bonded surface is at least 7 mm which is the initial width of the spacer.

X: Air bubbles are observed at the bonded surface between the flat glass and the spacer, or the bonded surface has a portion where the width is narrower than 7 mm which is the initial width of the spacer.

TABLE 1

| | | Viscosity-averaged | | | | | |
|---|---|---|---|---|---|---|---|
| Blend materials | Product name | molecular weight | Ex. 1 | Ex. 2 | Ex. 3 | Ex. 4 | Ex. 5 |
| Polyisobutylene | Oppanol B12 | 62000 | 23.08 | 17.02 | 25.53 | 19.15 | 28.57 |
| (parts by mass) | Vistanex MML80 | 900000 | 0 | 0 | 0 | 0 | 0 |
| | Oppanol B50 | 435000 | 0 | 0 | 0 | 0 | 0 |
| | Oppanol B80 | 905000 | 0 | 13.83 | 0 | 17.02 | 0 |
| | Oppanol B100 | 1300000 | 9.62 | 0 | 10.64 | 0 | 11.90 |
| | Oppanol B150 | 2900000 | 9.62 | 0 | 10.64 | 0 | 11.90 |

| | | | | | | |
|---|---|---|---|---|---|---|
| Crystalline | KM870A | 0 | 0 | 0 | 0 | 0 |
| polyolefin | | | | | | |
| (parts by mass) | | | | | | |
| Tackifier | Escorez 228F | 9.62 | 10.64 | 10.64 | 10.64 | 11.90 |
| (parts by mass) | | | | | | |
| Talc | LMS-300 | 19.23 | 26.60 | 10.64 | 21.28 | 0 |
| (parts by mass) | | | | | | |
| Carbon black | SEAST 3 | 9.62 | 10.64 | 10.64 | 10.64 | 11.90 |
| (parts by mass) | | | | | | |
| Zeolite | A4 powder | 19.23 | 21.28 | 21.28 | 21.28 | 23.81 |
| (parts by mass) | | | | | | |

| | | | | | |
|---|---|---|---|---|---|
| MWI | 9.9 × 10⁵ | 4.4 × 10⁵ | 9.9 × 10⁵ | 4.6 × 10⁵ | 9.9 × 10⁵ |
| Filler weight percentage (%) | 48.08 | 58.51 | 42.55 | 53.19 | 35.71 |
| MVR (cm³/sec) | 0.015 | 0.019 | 0.024 | 0.029 | 0.032 |

| | | Viscosity-averaged | | Comp. | Comp. | Comp. |
|---|---|---|---|---|---|---|
| Blend materials | Product name | molecular weight | Ex. 6 | Ex. 1 | Ex. 2 | Ex. 3 |
| Polyisobutylene | Oppanol B12 | 62000 | 25.53 | 25.53 | 8.70 | 21.28 |
| (parts by mass) | Vistanex MML80 | 900000 | 21.28 | 0 | 0 | 21.28 |
| | Oppanol B50 | 435000 | 0 | 23.81 | 8.70 | 0 |
| | Oppanol B80 | 905000 | 0 | 0 | 0 | 0 |
| | Oppanol B100 | 1300000 | 0 | 0 | 0 | 0 |
| | Oppanol B150 | 2900000 | 0 | 0 | 0 | 0 |

| | | | | | |
|---|---|---|---|---|---|
| Crystalline | KM870A | 0 | 0 | 0 | 4.26 |
| polyolefin | | | | | |
| (parts by mass) | | | | | |
| Tackifier | Escorez 228F | 10.64 | 11.90 | 4.35 | 10.64 |
| (parts by mass) | | | | | |
| Talc | LMS-300 | 10.64 | 0 | 26.09 | 10.64 |
| (parts by mass) | | | | | |
| Carbon black | SEAST 3 | 10.64 | 11.90 | 26.09 | 10.64 |
| (parts by mass) | | | | | |
| Zeolite | A4 powder | 21.28 | 23.81 | 26.09 | 21.28 |
| (parts by mass) | | | | | |

| | | | | |
|---|---|---|---|---|
| MWI | 4.4 × 10⁵ | 2.3 × 10⁵ | 2.3 × 10⁵ | 4.8 × 10⁵ |
| Filler weight percentage (%) | 42.55 | 35.71 | 78.26 | 42.55 |
| MVR (cm³/sec) | 0.049 | 0.126 | Evaluation | 0.025 |
| | | | impossible | |

TABLE 2

| Test items | | Ex. 1 | Ex. 2 | Ex. 3 | Ex. 4 | Ex. 5 |
|---|---|---|---|---|---|---|
| Glass interface-forming test | | ◯ | ◯ | ◯ | ◯ | ◯ |
| Opening and | Dew point of air in | <−60° C. | <−60° C. | <−60° C. | <−60° C. | <−60° C. |
| closing test | the air space after | | | | | |
| | the opening and | | | | | |
| | closing test (° C.) | | | | | |
| | Change in thickness of | <0.1 | <0.1 | 0.2 | 0.5 | 0.8 |
| | the double-glazing unit | | | | | |
| | after the opening and | | | | | |
| | closing test (mm) | | | | | |
| | Evaluation | Acceptable | Acceptable | Acceptable | Acceptable | Acceptable |
| Sheet | Displacement degree of | 0.8 | 0.6 | 1 | 1.2 | 1.5 |
| displacement | the unit after the | | | | | |
| test | sheet displacement | | | | | |
| | test (mm) | | | | | |
| | Evaluation | Acceptable | Acceptable | Acceptable | Acceptable | Acceptable |
| JIS R3209 | Dew point of air in | <−60° C. | <−60° C. | <−60° C. | <−60° C. | <−60° C. |
| (1988) Class | the air space after | | | | | |
| III | completion of JIS | | | | | |
| | R3209 (1998) Class III | | | | | |
| | Evaluation | Acceptable | Acceptable | Acceptable | Acceptable | Acceptable |

| Test items | | Ex. 6 | Comp. Ex. 1 | Comp. Ex. 2 | Comp. Ex. 3 |
|---|---|---|---|---|---|
| Glass interface-forming test | | ◯ | ◯ | Evaluation | X (The width of the |
| | | | | impossible | bonded surface of the |
| | | | | | spacer at corner |
| | | | | | portions of the |
| | | | | | double-glazing unit |
| | | | | | was 3 mm.) |
| Opening and | Dew point of air in | <−60° C. | <−60° C. | Kneading | <−60° C. |
| closing test | the air space after | | | impossible | |
| | the opening and | | | and test | |
| | closing test (° C.) | | | impossible | |
| | Change in thickness of | 1 | 3.2 | Kneading | <0.1 |
| | the double-glazing | | | impossible | |
| | unit after the opening | | | and test | |
| | and closing test (mm) | | | impossible | |
| | Evaluation | Acceptable | Not | Not | Acceptable |
| | | | acceptable | acceptable | |
| Sheet | Displacement degree of | 1.9 | 8 | Kneading | 0.2 |
| displacement | the unit after the | | | impossible | |
| test | sheet displacement | | | and test | |
| | test (mm) | | | impossible | |
| | Evaluation | Acceptable | Not | Not | Acceptable |
| | | | acceptable | acceptable | |
| JIS R3209 | Dew point of air in | <−60° C. | <−60° C. | Kneading | <−60° C. |
| (1988) Class III | the air space after | | | impossible | |
| | completion of JIS | | | and test | |
| | R3209 (1998) Class III | | | impossible | |
| | Evaluation | Acceptable | Acceptable | Not | Acceptable |
| | | | | acceptable | |

As shown in Table 2, in the single-sealed double-glazing units of the present invention wherein only an elastomer spacer was used as the spacer, the adhesion state between the flat glass and the spacer is good, the change in thickness of the double-glazing unit after the opening and closing test is small, and the sheet displacement degree is small, and yet they have excellent characteristics which are acceptable by the test of JIS R3209 (1998).

### INDUSTRIAL APPLICABILITY

According to the present invention, it is possible to obtain a single-sealed multilayer transparent unit which is excellent in shape retention as the creeping property of the spacer material becomes low, of which the water vapor permeability of the spacer material is low, and which is excellent in durability, and such a unit is widely applicable to e.g. windows for buildings and vehicles.

The entire disclosure of Japanese Patent Application No. 2004-138271 filed on May 7, 2004 including specification, claims, drawings and summary is incorporated herein by reference in its entirety.

What is claimed is:

1. A single-sealed multi-layer transparent unit, wherein as a spacer, only an elastomer spacer is used, and said spacer is disposed at a peripheral portion between at least two sheets of plate-like transparent material facing one another, and wherein said elastomer spacer contains, as the matrix component, at least one butyl elastomer component selected from the group consisting of polyisobutylene, butyl rubber and modified butyl rubber; Molecular Weight Index (MWI) of the butyl elastomer component represented by the following formula (1) is at least 400,000:
$$MWI = {\sum }_{i} ( Mw ( i ) \times ( mass \% of the i \text{-} th butyl elastomer component based on the total amount of all butyl elastomer components / 100 ) ) \qquad ( 1 )$$
(wherein i is an integer of at least 1 representing the number of types of butyl elastomer components contained as the matrix component in the elastomer spacer, and Mw(i) represents the viscosity-averaged molecular weight of the i-th butyl elastomer component); and the elastomer spacer contains no crystalline polyolefin.

2. The single-sealed multi-layer transparent unit according to claim 1, wherein the elastomer spacer contains, as filler components, a drying agent and at least one member selected from the group consisting of carbon black, coloring pigment and inorganic filler, and such filler components are contained in a total amount of from 40 to 75 mass % in the elastomer spacer.

3. The single-sealed multi-layer transparent unit according to claim 1, wherein the melt volume rate (MVR) of the material for the elastomer spacer is at most 0.1 cm³/sec, as measured in accordance with JIS K7210 (1999) by means of a Koka-type flow tester at 150° C. under a load of 55 kgf (539N) under a condition of die length (L)/die diameter (D)=5 mm/1 mm.

4. The single-sealed multi-layer transparent unit according to claim 1, wherein an adhesive is provided between the elastomer spacer and the plate-like transparent material.

5. The single-sealed multi-layer transparent unit according to claim 1, wherein the plate-like transparent material is flat glass, and the single-sealed multi-layer transparent unit is a single-sealed double-glazing unit.

6. A process for producing a single-sealed multi-layer transparent unit as defined in claim 1, which comprises producing a string-like elastomer spacer having prescribed size and shape as said elastomer spacer, by extrusion, then disposing the string-like elastomer spacer all around inside the periphery of the plate-like transparent material, and overlaying another plate-like transparent material to face said plate-like transparent material with the string-like elastomer spacer interposed.

7. A single-sealed multi-layer transparent unit, wherein as a spacer, only an elastomer spacer is used, and said spacer is disposed at a peripheral portion between at least two sheets of plate-like transparent material facing one another, and wherein said elastomer spacer contains, as the matrix component, at least one butyl elastomer component selected from the group consisting of polyisobutylene, butyl rubber and modified butyl rubber; Molecular Weight Index (MWI) of the butyl elastomer component represented by the following formula (1) is at least 400,000:
$$MWI = {\sum }_{i} ( Mw ( i ) \times ( mass \% of the i \text{-} th butyl elastomer component based on the total amount of all butyl elastomer components / 100 ) ) \qquad ( 1 )$$
(wherein i is an integer of at least 1 representing the number of types of butyl elastomer components contained as the matrix component in the elastomer spacer, and Mw(i) represents the viscosity-averaged molecular weight of the i-th butyl elastomer component); and the elastomer spacer contains less than 2 mass % of crystalline polyolefin.

8. The single-sealed multi-layer transparent unit according to claim 7, wherein the elastomer spacer contains, as filler components, a drying agent and at least one member selected from the group consisting of carbon black, coloring pigment and inorganic filler, and such filler components are contained in a total amount of from 40 to 75 mass % in the elastomer spacer.

9. The single-sealed multi-layer transparent unit according to claim 7, wherein the melt volume rate (MVR) of the material for the elastomer spacer is at most 0.1 cm³/sec, as measured in accordance with JIS K7210 (1999) by means of a Koka-type flow tester at 150° C. under a load of 55 kgf (539N) under a condition of die length (L)/die diameter (D)=5 mm/1 mm.

10. The single-sealed multi-layer transparent unit according to claim 7, wherein an adhesive is provided between the elastomer spacer and the plate-like transparent material.

11. The single-sealed multi-layer transparent unit according to claim 7, wherein the plate-like transparent material is flat glass, and the single-sealed multi-layer transparent unit is a single-sealed double-glazing unit.

12. A process for producing a single-sealed multi-layer transparent unit as defined in claim 7, which comprises producing a string-like elastomer spacer having prescribed size and shape as said elastomer spacer, by extrusion, then disposing the string-like elastomer spacer all around inside the periphery of the plate-like transparent material, and overlaying another plate-like transparent material to face said plate-like transparent material with the string-like elastomer spacer interposed.
